(19) United States
(12) Patent Application Publication
(10) Pub. No.: US 2023/0410486 A1
(43) Pub. Date: Dec. 21, 2023

(54) INFORMATION PROCESSING APPARATUS, INFORMATION PROCESSING METHOD, AND PROGRAM

(71) Applicant: SONY GROUP CORPORATION, TOKYO (JP)

(72) Inventor: GUIFEN TIAN, TOKYO (JP)

(21) Appl. No.: 18/252,219

(22) PCT Filed: Nov. 4, 2021
(86) PCT No.: PCT/JP2021/040484

§ 371 Date: May 9, 2023

(30) Foreign Application Priority Data
Nov. 17, 2020 (JP) 2020-190708

(51) Int. Cl. G06V 10/776; G06V 20/58; G06V 10/778

(52) U.S. Cl. CPC G06V 10/776; G06V 20/58; G06V 10/778

(57) ABSTRACT

The present technology relates to an information processing apparatus, an information processing method, and a program that enable efficient relearning of a recognition model. An information processing apparatus includes: a collection timing control unit configured to control a timing to collect a learning image candidate that is an image to be a candidate for a learning image to be used in relearning of a recognition model; and a learning image collection unit configured to select the learning image from among the learning image candidates that have been collected, on the basis of at least one of a feature of the learning image candidate or a similarity to the learning image that has been accumulated. The present technology can be applied to, for example, a system that controls automated driving.

### TECHNICAL FIELD

The present technology relates to an information processing apparatus, an information processing method, and a program, and particularly to an information processing apparatus, an information processing method, and a program suitable for use in a case of relearning a recognition model.

### BACKGROUND ART

In an automated driving system, a recognition model for recognizing various recognition targets around a vehicle is used. Furthermore, there is a case where the recognition model is updated in order to keep favorable accuracy of the recognition model (see, for example, Patent Document 1).

### CITATION LIST

### Patent Document

Patent Document 1: Japanese Patent Application Laid-Open No. 2020-26985

### SUMMARY OF THE INVENTION

### Problems to be Solved by the Invention

In a case where the recognition model of the automated driving system is updated, it is desirable to enable relearning of the recognition model as efficiently as possible.

The present technology has been made in view of such a situation, and is to enable efficient relearning of a recognition model.

### Solutions to Problems

An information processing apparatus according to one aspect of the present technology includes: a collection timing control unit configured to control a timing to collect a learning image candidate that is an image to be a candidate for a learning image to be used in relearning of a recognition model; and a learning image collection unit configured to select the learning image from among the learning image candidates that have been collected, on the basis of at least one of a feature of the learning image candidate or a similarity to the learning image that has been accumulated.

An information processing method according to one aspect of the present technology includes, by the information processing apparatus: controlling a timing to collect a learning image candidate that is an image to be a candidate for a learning image to be used in relearning of a recognition model; and selecting the learning image from among the learning image candidates that have been collected, on the basis of at least one of a feature of the learning image candidate or a similarity to the learning image that has been accumulated.

A program according to one aspect of the present technology causes a computer to execute processing including: controlling a timing to collect a learning image candidate that is an image to be a candidate for a learning image to be used in relearning of a recognition model; and selecting the learning image from among the learning image candidates that have been collected, on the basis of at least one of a feature of the learning image candidate or a similarity to the learning image that has been accumulated.

In one aspect of the present technology, control is performed on a timing to collect a learning image candidate that is an image to be a candidate for a learning image to be used in relearning of a recognition model, and the learning image is selected from among the learning image candidates that have been collected, on the basis of at least one of a feature of the learning image candidate or a similarity to the learning image that has been accumulated.

### BRIEF DESCRIPTION OF DRAWINGS

FIG. 1 is a block diagram illustrating a configuration example of a vehicle control system.

FIG. 2 is a view illustrating an example of a sensing area.

FIG. 3 is a block diagram illustrating an embodiment of an information processing system to which the present technology is applied.

FIG. 4 is a block diagram illustrating a configuration example of an information processing unit of FIG. 3.

FIG. 5 is a flowchart for explaining recognition model learning processing.

FIG. 6 is a diagram for explaining a specific example of recognition processing.

FIG. 7 is a flowchart for explaining a first embodiment of reliability threshold value setting processing.

FIG. 8 is a flowchart for explaining a second embodiment of the reliability threshold value setting processing.

FIG. 9 is a graph illustrating an example of a PR curve.

FIG. 10 is a flowchart for explaining verification image collection processing.

FIG. 11 is a view illustrating a format example of verification image data.

FIG. 12 is a flowchart for explaining dictionary data generation processing.

FIG. 13 is a flowchart for explaining verification image classification processing.

FIG. 14 is a flowchart for explaining learning image collection processing.

FIG. 15 is a view illustrating a format example of learning image data.

FIG. 16 is a flowchart for explaining recognition model update processing.

FIG. 17 is a flowchart for explaining details of recognition model verification processing using a high-reliability verification image.

FIG. 18 is a flowchart for explaining details of recognition model verification processing using a low-reliability verification image.

FIG. 19 is a block diagram illustrating a configuration example of a computer.

### MODE FOR CARRYING OUT THE INVENTION

Hereinafter, an embodiment for implementing the present technology will be described. The description will be given in the following order.
1. Configuration example of vehicle control system
2. Embodiment
3. Modified example
4. Other

### 1. Configuration Example of Vehicle Control System

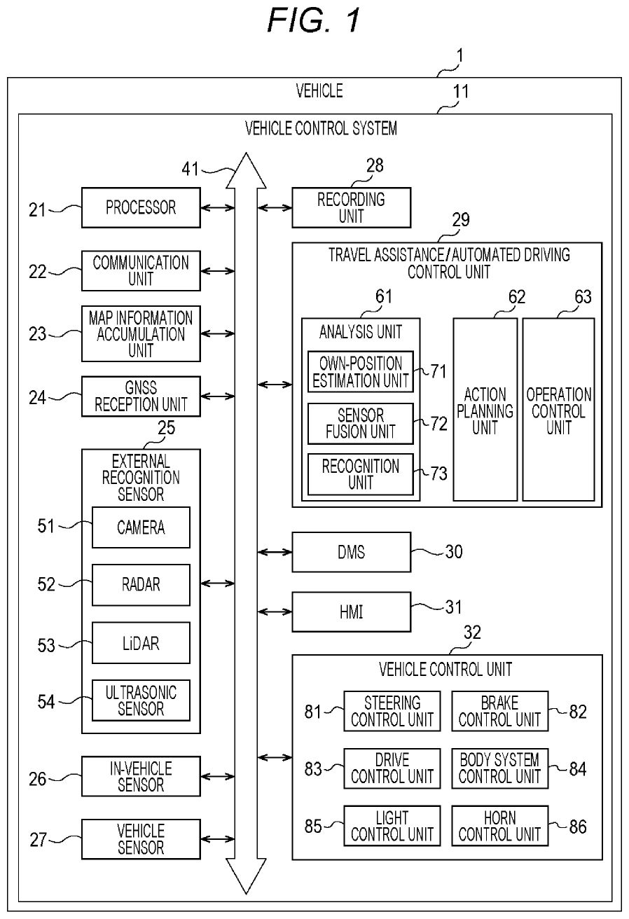

FIG. 1 is a block diagram illustrating a configuration example of a vehicle control system 11, which is an example of a mobile device control system to which the present technology is applied.

The vehicle control system 11 is provided in a vehicle 1 and performs processing related to travel assistance and automated driving of the vehicle 1.

The vehicle control system 11 includes a processor 21, a communication unit 22, a map information accumulation unit 23, a global navigation satellite system (GNSS) reception unit 24, an external recognition sensor 25, an in-vehicle sensor 26, a vehicle sensor 27, a recording unit 28, a travel assistance/automated driving control unit 29, a driver monitoring system (DMS) 30, a human machine interface (HMI) 31, and a vehicle control unit 32.

The processor 21, the communication unit 22, the map information accumulation unit 23, the GNSS reception unit 24, the external recognition sensor 25, the in-vehicle sensor 26, the vehicle sensor 27, the recording unit 28, the travel assistance/automated driving control unit 29, the driver monitoring system (DMS) 30, the human machine interface (HMI) 31, and the vehicle control unit 32 are connected to each other via a communication network 41. The communication network 41 includes, for example, a bus, an in-vehicle communication network conforming to any standard such as a controller area network (CAN), a local interconnect network (LIN), a local area network (LAN), FlexRay, or Ethernet (registered trademark), and the like. Note that there is also a case where each unit of the vehicle control system 11 is directly connected by, for example, short-range wireless communication (near field communication (NFC)), Bluetooth (registered trademark), or the like without via the communication network 41.

Note that, hereinafter, in a case where each unit of the vehicle control system 11 communicates via the communication network 41, the description of the communication network 41 is to be omitted. For example, in a case where the processor 21 and the communication unit 22 perform communication via the communication network 41, it is simply described that the processor 21 and the communication unit 22 perform communication.

The processor 21 includes various processors such as, for example, a central processing unit (CPU), a micro processing unit (MPU), and an electronic control unit (ECU). The processor 21 controls the entire vehicle control system 11.

The communication unit 22 communicates with various types of equipment inside and outside the vehicle, other vehicles, servers, base stations, and the like, and transmits and receives various data. As the communication with the outside of the vehicle, for example, the communication unit 22 receives, from the outside, a program for updating software for controlling an operation of the vehicle control system 11, map information, traffic information, information around the vehicle 1, and the like. For example, the communication unit 22 transmits information regarding the vehicle 1 (for example, data indicating a state of the vehicle 1, a recognition result by a recognition unit 73, and the like), information around the vehicle 1, and the like to the outside. For example, the communication unit 22 performs communication corresponding to a vehicle emergency call system such as an eCall.

Note that a communication method of the communication unit 22 is not particularly limited. Furthermore, a plurality of communication methods may be used.

As the communication with the inside of the vehicle, for example, the communication unit 22 performs wireless communication with in-vehicle equipment by a communication method such as wireless LAN, Bluetooth, NFC, or wireless USB (WUSB). For example, the communication unit 22 performs wired communication with in-vehicle equipment through a communication method such as a universal serial bus (USB), a high-definition multimedia interface (HDMI, registered trademark), or a mobile high-definition link (MHL), via a connection terminal (not illustrated) (and a cable if necessary).

Here, the in-vehicle equipment is, for example, equipment that is not connected to the communication network 41 in the vehicle. For example, mobile equipment or wearable equipment carried by a passenger such as a driver, information equipment brought into the vehicle and temporarily installed, and the like are assumed.

For example, the communication unit 22 uses a wireless communication method such as a fourth generation mobile communication system (4G), a fifth generation mobile communication system (5G), long term evolution (LTE), or dedicated short range communications (DSRC), to communicate with a server or the like existing on an external network (for example, the Internet, a cloud network, or a company-specific network) via a base station or an access point.

For example, the communication unit 22 uses a peer to peer (P2P) technology to communicate with a terminal (for example, a terminal of a pedestrian or a store, or a machine type communication (MTC) terminal) existing near the own vehicle. For example, the communication unit 22 performs V2X communication. The V2X communication is, for example, vehicle to vehicle communication with another vehicle, vehicle to infrastructure communication with a roadside device or the like, vehicle to home communication, vehicle to pedestrian communication with a terminal or the like possessed by a pedestrian, or the like.

For example, the communication unit 22 receives an electromagnetic wave transmitted by a road traffic information communication system (vehicle information and communication system (VICS), registered trademark), such as a radio wave beacon, an optical beacon, or FM multiplex broadcasting.

The map information accumulation unit 23 accumulates a map acquired from the outside and a map created by the vehicle 1. For example, the map information accumulation unit 23 accumulates a three-dimensional high-precision map, a global map having lower accuracy than the high-precision map and covering a wide area, and the like.

The high-precision map is, for example, a dynamic map, a point cloud map, a vector map (also referred to as an advanced driver assistance system (ADAS) map), or the like. The dynamic map is, for example, a map including four layers of dynamic information, semi-dynamic information, semi-static information, and static information, and is supplied from an external server or the like. The point cloud map is a map including a point cloud (point group data). The vector map is a map in which information such as a lane and a position of a traffic light is associated with the point cloud map. The point cloud map and the vector map may be supplied from, for example, an external server or the like, or may be created by the vehicle 1 as a map for performing matching with a local map to be described later on the basis of a sensing result by a radar 52, a LiDAR 53, or the like, and may be accumulated in the map information accumulation unit 23. Furthermore, in a case where the high-precision map is supplied from an external server or the like, in order to reduce a communication capacity, for example, map data of several hundred meters square regarding a planned path on which the vehicle 1 will travel is acquired from a server or the like.

The GNSS reception unit 24 receives a GNSS signal from a GNSS satellite, and supplies to the travel assistance/automated driving control unit 29.

The external recognition sensor 25 includes various sensors used for recognizing a situation outside the vehicle 1, and supplies sensor data from each sensor to each unit of the vehicle control system 11. Any type and number of sensors included in the external recognition sensor 25 may be adopted.

For example, the external recognition sensor 25 includes, a camera 51, the radar 52, the light detection and ranging or laser imaging detection and ranging (LiDAR) 53, and an ultrasonic sensor 54. Any number of the camera 51, the radar 52, the LiDAR 53, and the ultrasonic sensor 54 may be adopted, and an example of a sensing area of each sensor will be described later.

Note that, as the camera 51, for example, a camera of any image capturing system such as a time of flight (ToF) camera, a stereo camera, a monocular camera, or an infrared camera is used as necessary.

Furthermore, for example, the external recognition sensor 25 includes an environment sensor for detection of weather, a meteorological state, a brightness, and the like. The environment sensor includes, for example, a raindrop sensor, a fog sensor, a sunshine sensor, a snow sensor, an illuminance sensor, and the like.

Moreover, for example, the external recognition sensor 25 includes a microphone to be used to detect sound around the vehicle 1, a position of a sound source, and the like.

The in-vehicle sensor 26 includes various sensors for detection of information inside the vehicle, and supplies sensor data from each sensor to each unit of the vehicle control system 11. Any type and number of sensors included in the in-vehicle sensor 26 may be adopted.

For example, the in-vehicle sensor 26 includes a camera, a radar, a seating sensor, a steering wheel sensor, a microphone, a biological sensor, and the like. As the camera, for example, a camera of any image capturing system such as a ToF camera, a stereo camera, a monocular camera, or an infrared camera can be used. The biological sensor is provided, for example, in a seat, a steering wheel, or the like, and detects various kinds of biological information of a passenger such as the driver.

The vehicle sensor 27 includes various sensors for detection of a state of the vehicle 1, and supplies sensor data from each sensor to each unit of the vehicle control system 11. Any type and number of sensors included in the vehicle sensor 27 may be adopted.

For example, the vehicle sensor 27 includes a speed sensor, an acceleration sensor, an angular velocity sensor (gyro sensor), and an inertial measurement unit (IMU). For example, the vehicle sensor 27 includes a steering angle sensor that detects a steering angle of a steering wheel, a yaw rate sensor, an accelerator sensor that detects an operation amount of an accelerator pedal, and a brake sensor that detects an operation amount of a brake pedal. For example, the vehicle sensor 27 includes a rotation sensor that detects a number of revolutions of an engine or a motor, an air pressure sensor that detects an air pressure of a tire, a slip rate sensor that detects a slip rate of a tire, and a wheel speed sensor that detects a rotation speed of a wheel. For example, the vehicle sensor 27 includes a battery sensor that detects a remaining amount and a temperature of a battery, and an impact sensor that detects an external impact.

The recording unit 28 includes, for example, a magnetic storage device such as a read only memory (ROM), a random access memory (RAN), and a hard disc drive (HDD), a semiconductor storage device, an optical storage device, a magneto-optical storage device, and the like. The recording unit 28 stores various programs, data, and the like used by each unit of the vehicle control system 11. For example, the recording unit 28 records a rosbag file including a message transmitted and received by a Robot Operating System (ROS) in which an application program related to automated driving operates. For example, the recording unit 28 includes an Event Data Recorder (EDR) and a Data Storage System for Automated Driving (DSSAD), and records information of the vehicle 1 before and after an event such as an accident.

The travel assistance/automated driving control unit 29 controls travel support and automated driving of the vehicle 1. For example, the travel assistance/automated driving control unit 29 includes an analysis unit 61, an action planning unit 62, and an operation control unit 63.

The analysis unit 61 performs analysis processing on a situation of the vehicle 1 and surroundings. The analysis unit 61 includes an own-position estimation unit 71, a sensor fusion unit 72, and the recognition unit 73.

The own-position estimation unit 71 estimates an own-position of the vehicle 1 on the basis of sensor data from the external recognition sensor 25 and a high-precision map accumulated in the map information accumulation unit 23. For example, the own-position estimation unit 71 generates a local map on the basis of sensor data from the external recognition sensor 25, and estimates the own-position of the vehicle 1 by performing matching of the local map with the high-precision map. The position of the vehicle 1 is based on, for example, a center of a rear wheel pair axle.

The local map is, for example, a three-dimensional high-precision map, an occupancy grid map, or the like created using a technique such as simultaneous localization and mapping (SLAM). The three-dimensional high-precision map is, for example, the above-described point cloud map or the like. The occupancy grid map is a map in which a three-dimensional or two-dimensional space around the vehicle 1 is segmented into grids of a predetermined size, and an occupancy state of an object is indicated in a unit of a grid. The occupancy state of the object is indicated by, for example, a presence or absence or a presence probability of the object. The local map is also used for detection processing and recognition processing of a situation outside the vehicle 1 by the recognition unit 73, for example.

Note that the own-position estimation unit 71 may estimate the own-position of the vehicle 1 on the basis of a GNSS signal and sensor data from the vehicle sensor 27.

The sensor fusion unit 72 performs sensor fusion processing of combining a plurality of different types of sensor data (for example, image data supplied from the camera 51 and sensor data supplied from the radar 52) to obtain new information. Methods for combining different types of sensor data include integration, fusion, association, and the like.

The recognition unit 73 performs detection processing and recognition processing of a situation outside the vehicle 1.

For example, the recognition unit 73 performs detection processing and recognition processing of a situation outside the vehicle 1 on the basis of information from the external recognition sensor 25, information from the own-position estimation unit 71, information from the sensor fusion unit 72, and the like.

Specifically, for example, the recognition unit 73 performs detection processing, recognition processing, and the like of an object around the vehicle 1. The detection processing of the object is, for example, processing of detecting a presence or absence, a size, a shape, a position, a movement, and the like of the object. The recognition processing of the object is, for example, processing of recognizing an attribute such as a type of the object or identifying a specific object. However, the detection processing and the recognition processing are not necessarily clearly segmented, and may overlap.

For example, the recognition unit 73 detects an object around the vehicle 1 by performing clustering for classifying a point cloud on the basis of sensor data of the LiDAR, the radar, or the like for each cluster of point groups. As a result, a presence or absence, a size, a shape, and a position of the object around the vehicle 1 are detected.

For example, the recognition unit 73 detects a movement of the object around the vehicle 1 by performing tracking that is following a movement of the cluster of point groups classified by clustering. As a result, a speed and a traveling direction (a movement vector) of the object around the vehicle 1 are detected.

For example, the recognition unit 73 recognizes a type of the object around the vehicle 1 by performing object recognition processing such as semantic segmentation on an image data supplied from the camera 51.

Note that, as the object to be detected or recognized, for example, a vehicle, a person, a bicycle, an obstacle, a structure, a road, a traffic light, a traffic sign, a road sign, and the like are assumed.

For example, the recognition unit 73 performs recognition processing of traffic rules around the vehicle 1 on the basis of a map accumulated in the map information accumulation unit 23, an estimation result of the own-position, and a recognition result of the object around the vehicle 1. By this processing, for example, a position and a state of a traffic light, contents of a traffic sign and a road sign, contents of a traffic regulation, a travelable lane, and the like are recognized.

For example, the recognition unit 73 performs recognition processing of a surrounding environment of the vehicle 1. As the surrounding environment to be recognized, for example, weather, a temperature, a humidity, a brightness, road surface conditions, and the like are assumed.

The action planning unit 62 creates an action plan of the vehicle 1. For example, the action planning unit 62 creates an action plan by performing processing of path planning and path following.

Note that the path planning (global path planning) is processing of planning a rough path from a start to a goal. This path planning is called track planning, and also includes processing of track generation (local path planning) that enables safe and smooth traveling in the vicinity of the vehicle 1, in consideration of motion characteristics of the vehicle 1 in the path planned by the path planning.

Path following is processing of planning an operation for safely and accurately traveling a path planned by the path planning within a planned time. For example, a target speed and a target angular velocity of the vehicle 1 are calculated.

The operation control unit 63 controls an operation of the vehicle 1 in order to realize the action plan created by the action planning unit 62.

For example, the operation control unit 63 controls a steering control unit 81, a brake control unit 82, and a drive control unit 83 to perform acceleration/deceleration control and direction control such that the vehicle 1 travels on a track calculated by the track planning. For example, the operation control unit 63 performs cooperative control for the purpose of implementing functions of the ADAS, such as collision avoidance or impact mitigation, follow-up traveling, vehicle speed maintaining traveling, collision warning of the own vehicle, lane deviation warning of the own vehicle, and the like. Furthermore, for example, the operation control unit 63 performs cooperative control for the purpose of automated driving or the like of autonomously traveling without depending on an operation of the driver.

The DMS 30 performs driver authentication processing, recognition processing of a state of the driver, and the like on the basis of sensor data from the in-vehicle sensor 26, input data inputted to the HMI 31, and the like. As the state of the driver to be recognized, for example, a physical condition, an awakening level, a concentration level, a fatigue level, a line-of-sight direction, a drunkenness level, a driving operation, a posture, and the like are assumed.

Note that the DMS 30 may perform authentication processing of a passenger other than the driver and recognition processing of a state of the passenger. Furthermore, for example, the DMS 30 may perform recognition processing of a situation inside the vehicle on the basis of sensor data from the in-vehicle sensor 26. As the situation inside the vehicle to be recognized, for example, a temperature, a humidity, a brightness, odor, and the like are assumed.

The HMI 31 is used for inputting various data, instructions, and the like, generates an input signal on the basis of the inputted data, instructions, and the like, and supplies to each unit of the vehicle control system 11. For example, the HMI 31 includes: operation devices such as a touch panel, a button, a microphone, a switch, and a lever; an operation device that can be inputted by a method other than manual operation, such as with voice or a gesture; and the like. Note that, for example, the HMI 31 may be a remote control device using infrared ray or other radio waves, or external connection equipment such as mobile equipment or wearable equipment corresponding to an operation of the vehicle control system 11.

Furthermore, the HMI 31 performs output control to control generation and output of visual information, auditory information, and tactile information to the passenger or the outside of the vehicle, and to control output contents, output timings, an output method, and the like. The visual information is, for example, information indicated by an image or light such as an operation screen, a state display of the vehicle 1, a warning display, or a monitor image indicating a situation around the vehicle 1. The auditory information is, for example, information indicated by sound such as guidance, warning sound, or a warning message. The tactile information is, for example, information given to a tactile sense of the passenger by a force, a vibration, a movement, or the like.

As a device that outputs visual information, for example, a display device, a projector, a navigation device, an instrument panel, a camera monitoring system (CMS), an electronic mirror, a lamp, and the like are assumed. The display device may be, for example, a device that displays visual information in a passenger's field of view, such as a head-up display, a transmissive display, or a wearable device having an augmented reality (AR) function, in addition to a device having a normal display.

As a device that outputs auditory information, for example, an audio speaker, a headphone, an earphone, or the like is assumed.

As a device that outputs tactile information, for example, a haptic element using haptic technology, or the like, is assumed. The haptic element is provided, for example, on the steering wheel, a seat, or the like.

The vehicle control unit 32 controls each unit of the vehicle 1. The vehicle control unit 32 includes the steering control unit 81, the brake control unit 82, the drive control unit 83, a body system control unit 84, a light control unit 85, and a horn control unit 86.

The steering control unit 81 performs detection, control, and the like of a state of a steering system of the vehicle 1. The steering system includes, for example, a steering mechanism including the steering wheel and the like, an electric power steering, and the like. The steering control unit 81 includes, for example, a controlling unit such as an ECU that controls the steering system, an actuator that drives the steering system, and the like.

The brake control unit 82 performs detection, control, and the like of a state of a brake system of the vehicle 1. The brake system includes, for example, a brake mechanism including a brake pedal, an antilock brake system (ABS), and the like. The brake control unit 82 includes, for example, a controlling unit such as an ECU that controls a brake system, an actuator that drives the brake system, and the like.

The drive control unit 83 performs detection, control, and the like of a state of a drive system of the vehicle 1. The drive system includes, for example, an accelerator pedal, a driving force generation device for generation of a driving force such as an internal combustion engine or a driving motor, a driving force transmission mechanism for transmission of the driving force to wheels, and the like. The drive control unit 83 includes, for example, a controlling unit such as an ECU that controls the drive system, an actuator that drives the drive system, and the like.

The body system control unit 84 performs detection, control, and the like of a state of a body system of the vehicle 1. The body system includes, for example, a keyless entry system, a smart key system, a power window device, a power seat, an air conditioner, an airbag, a seat belt, a shift lever, and the like. The body system control unit 84 includes, for example, a controlling unit such as an ECU that controls the body system, an actuator that drives the body system, and the like.

The light control unit 85 performs detection, control, and the like of a state of various lights of the vehicle 1. As the lights to be controlled, for example, a headlight, a backlight, a fog light, a turn signal, a brake light, a projection, a display of a bumper, and the like are assumed. The light control unit 85 includes a controlling unit such as an ECU that controls lights, an actuator that drives lights, and the like.

The horn control unit 86 performs detection, control, and the like of state of a car horn of the vehicle 1. The horn control unit 86 includes, for example, a controlling unit such as an ECU that controls the car horn, an actuator that drives the car horn, and the like.

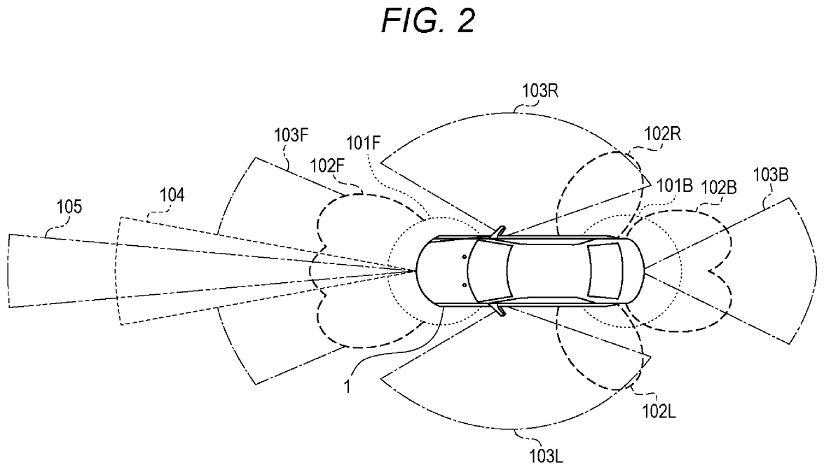

FIG. 2 is a view illustrating an example of a sensing area by the camera 51, the radar 52, the LiDAR 53, and the ultrasonic sensor 54 of the external recognition sensor 25 in FIG. 1.

Sensing areas 101F and 101B illustrate examples of sensing areas of the ultrasonic sensor 54. The sensing area 101F covers a periphery of a front end of the vehicle 1. The sensing area 101B covers a periphery of a rear end of the vehicle 1.

Sensing results in the sensing areas 101F and 101B are used, for example, for parking assistance and the like of the vehicle 1.

Sensing areas 102F to 102B illustrate examples of sensing areas of the radar 52 for a short distance or a middle distance. The sensing area 102F covers a position farther than the sensing area 101F in front of the vehicle 1. The sensing area 102B covers a position farther than the sensing area 101B behind the vehicle 1. The sensing area 102L covers a rear periphery of a left side surface of the vehicle 1. The sensing area 102R covers a rear periphery of a right side surface of the vehicle 1.

A sensing result in the sensing area 102F is used, for example, for detection of a vehicle, a pedestrian, or the like existing in front of the vehicle 1, and the like. A sensing result in the sensing area 102B is used, for example, for a collision prevention function or the like behind the vehicle 1. Sensing results in the sensing areas 102L and 102R are used, for example, for detection of an object in a blind spot on a side of the vehicle 1, and the like.

Sensing areas 103F to 103B illustrate examples of sensing areas by the camera 51. The sensing area 103F covers a position farther than the sensing area 102F in front of the vehicle 1. The sensing area 103B covers a position farther than the sensing area 102B behind the vehicle 1. The sensing area 103L covers a periphery of a left side surface of the vehicle 1. The sensing area 103R covers a periphery of a right side surface of the vehicle 1.

A sensing result in the sensing area 103F is used for, for example, recognition of a traffic light or a traffic sign, a lane departure prevention assist system, and the like. A sensing result in the sensing area 103B is used for, for example, parking assistance, a surround view system, and the like. Sensing results in the sensing areas 103L and 103R are used, for example, in a surround view system or the like.

A sensing area 104 illustrates an example of a sensing area of the LiDAR 53. The sensing area 104 covers a position farther than the sensing area 103F in front of the vehicle 1. Whereas, the sensing area 104 has a narrower range in a left-right direction than the sensing area 103F.

A sensing result in the sensing area 104 is used for, for example, emergency braking, collision avoidance, pedestrian detection, and the like.

A sensing area 105 illustrates an example of a sensing area of the radar 52 for a long distance. The sensing area 105 covers a position farther than the sensing area 104 in front of the vehicle 1. Whereas, the sensing area 105 has a narrower range in a left-right direction than the sensing area 104.

A sensing result in the sensing area 105 is used for, for example, adaptive cruise control (ACC) and the like.

Note that the sensing area of each sensor may have various configurations other than those in FIG. 2. Specifically, the ultrasonic sensor 54 may also perform sensing on a side of the vehicle 1, or the LiDAR 53 may perform sensing behind the vehicle 1.

### 2. Embodiment

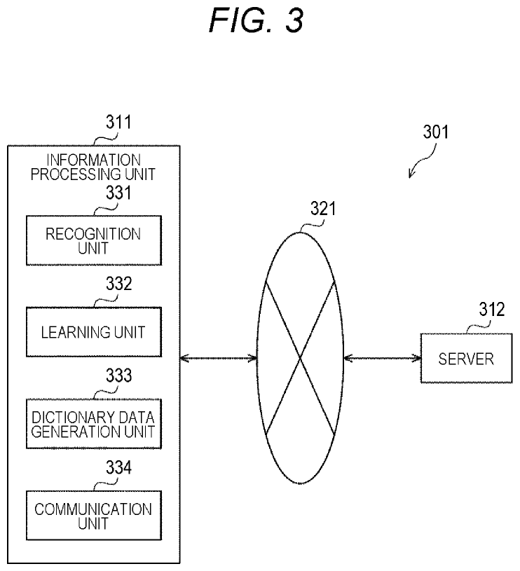

Next, an embodiment of the present technology will be described with reference to FIGS. 3 to 18.

<Configuration Example of Information Processing System>

FIG. 3 illustrates an embodiment of an information processing system 301 to which the present technology is applied.

The information processing system 301 is a system that learns and updates a recognition model for recognizing a specific recognition target in the vehicle 1. The recognition target of the recognition model is not particularly limited, but for example, the recognition model is assumed to perform depth recognition, semantic segmentation, optical flow recognition, and the like.

The information processing system 301 includes an information processing unit 311 and a server 312. The information processing unit 311 includes a recognition unit 331, a learning unit 332, a dictionary data generation unit 333, and a communication unit 334.

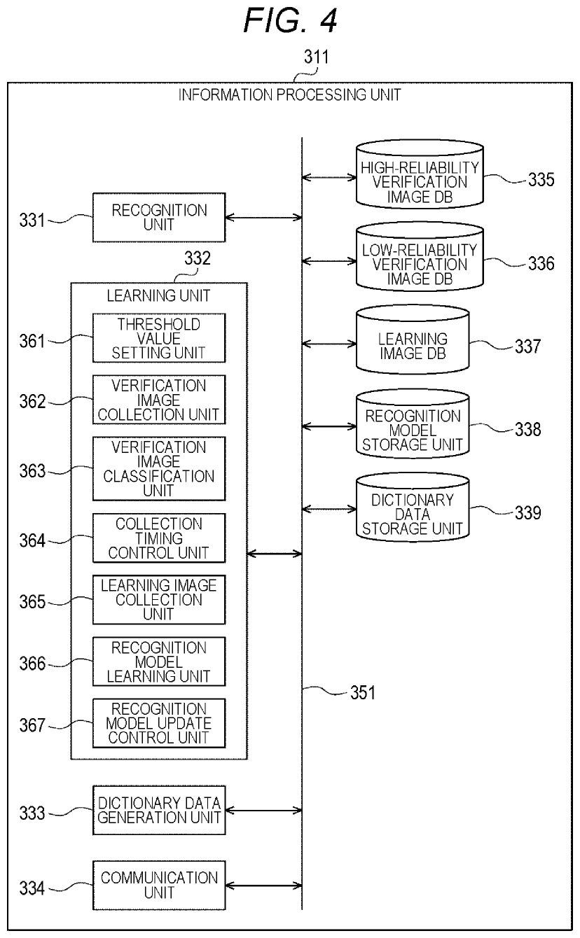

The recognition unit 331 constitutes, for example, a part of the recognition unit 73 in FIG. 1. The recognition unit 331 executes recognition processing of recognizing a predetermined recognition target by using a recognition model learned by the learning unit 332 and stored in a recognition model storage unit 338 (FIG. 4). For example, the recognition unit 331 recognizes a predetermined recognition target for every pixel of an image (hereinafter, referred to as a captured image) captured by the camera 51 (an image sensor) in FIG. 1, and estimates reliability of a recognition result.

Note that the recognition unit 331 may recognize a plurality of recognition targets. In this case, for example, a different recognition model is used for every recognition target.

The learning unit 332 learns a recognition model used by the recognition unit 331. The learning unit 332 may be provided in the vehicle control system 11 of FIG. 1 or may be provided outside the vehicle control system 11. In a case where the learning unit 332 is provided in the vehicle control system 11, for example, the learning unit 332 may constitute a part of the recognition unit 73, or may be provided separately from the recognition unit 73. Furthermore, for example, a part of the learning unit 332 may be provided in the vehicle control system 11, and the rest may be provided outside the vehicle control system 11.

The dictionary data generation unit 333 generates dictionary data for classifying types of images. The dictionary data generation unit 333 causes a dictionary data storage unit 339 (FIG. 4) to store the generated dictionary data. The dictionary data includes a feature pattern corresponding to each type of images.

The communication unit 334 constitutes, for example, a part of the communication unit 22 in FIG. 1. The communication unit 334 communicates with the server 312 via a network 321.

The server 312 performs recognition processing similar to that of the recognition unit 331 by using software for a benchmark test, and executes a benchmark test for verifying accuracy of the recognition processing. The server 312 transmits data including a result of the benchmark test to the information processing unit 311 via the network 321.

Note that a plurality of servers 312 may be provided.

<Configuration Example of Information Processing Unit 311>

FIG. 4 illustrates a detailed configuration example of the information processing unit 311 in FIG. 3.

The information processing unit 311 includes a high-reliability verification image data base (DB) 335, a low-reliability verification image data base (DB) 336, a learning image data base (DB) 337, the recognition model storage unit 338, and the dictionary data storage unit 339, in addition to the recognition unit 331, the learning unit 332, the dictionary data generation unit 333, and the communication unit 334 described above. The recognition unit 331, the learning unit 332, the dictionary data generation unit 333, the communication unit 334, the high-reliability verification image DB 335, the low-reliability verification image DB 336, the learning image DB 337, the recognition model storage unit 338, and the dictionary data storage unit 339 are connected to each other via a communication network 351. The communication network 351 constitutes, for example, a part of the communication network 41 in FIG. 1.

Note that, hereinafter, in the information processing unit 311, the description of the communication network 351 in a case where communication is performed via the communication network 351 is to be omitted. For example, in a case where the recognition unit 331 and a recognition model learning unit 366 perform communication via the communication network 351, the description of the communication network 351 is to be omitted, and it is simply described that the recognition unit 331 and the recognition model learning unit 366 perform communication.

The learning unit 332 includes a threshold value setting unit 361, a verification image collection unit 362, a verification image classification unit 363, a collection timing control unit 364, a learning image collection unit 365, the recognition model learning unit 366, and a recognition model update control unit 367.

The threshold value setting unit 361 sets a threshold value (hereinafter, referred to as a reliability threshold value) to be used for determination of reliability of a recognition result of a recognition model.

The verification image collection unit 362 collects a verification image by selecting a verification image from among images (hereinafter, referred to as verification image candidates) that are candidates for a verification image to be used for verification of a recognition model, on the basis of a predetermined condition. The verification image collection unit 362 classifies the verification images into high-reliability verification images or low-reliability verification images, on the basis of reliability of a recognition result for a verification image of the currently used recognition model (hereinafter, referred to as a current recognition model) and the reliability threshold value set by the threshold value setting unit 361. The high-reliability verification image is a verification image in which the reliability of the recognition result is higher than the reliability threshold value and the recognition accuracy is favorable. The low-reliability verification image is a verification image in which the reliability of the recognition result is lower than the reliability threshold value and improvement in recognition accuracy is required. The verification image collection unit 362 accumulates the high-reliability verification images in the high-reliability verification image DB 335 and accumulates the low-reliability verification images in the low-reliability verification image DB 336.

The verification image classification unit 363 classifies the low-reliability verification image into each type by using a feature pattern of the low-reliability verification image, on the basis of dictionary data accumulated in the dictionary data storage unit 339. The verification image classification unit 363 gives a label indicating a feature pattern of the low-reliability verification image to the verification image.

The collection timing control unit 364 controls a timing to collect images (hereinafter, referred to as learning image candidates) that are candidates for a learning image to be used for learning of a recognition model.

The learning image collection unit 365 collects the learning image by selecting the learning image from among the learning image candidates, on the basis of a predetermined condition. The learning image collection unit 365 accumulates the learning images that have been collected in the learning image DB 337.

The recognition model learning unit 366 learns the recognition model by using the learning images accumulated in the learning image DB 337.

By using the high-reliability verification images accumulated in the high-reliability verification image DB 335 and the low-reliability verification images accumulated in the low-reliability verification image DB 336, the recognition model update control unit 367 verifies a recognition model (hereinafter, referred to as a new recognition model) newly relearned by the recognition model learning unit 366. The recognition model update control unit 367 controls update of the recognition model on the basis of a verification result of the new recognition model. When the recognition model update control unit 367 determines to update the recognition model, the recognition model update control unit 367 updates the current recognition model stored in the recognition model storage unit 338 to the new recognition model.

<Processing of Information Processing System 301>

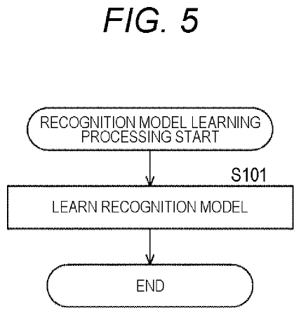

Next, with reference to FIGS. 5 to 18, processing of the information processing system 301 will be described.

<Recognition Model Learning Processing>

First, with reference to a flowchart of FIG. 5, recognition model learning processing executed by the recognition model learning unit 366 will be described.

This processing is executed, for example, when learning of the recognition model to be used for the recognition unit 331 is first performed.

In step S101, the recognition model learning unit 366 learns a recognition model.

For example, the recognition model learning unit 366 learns the recognition model by using a loss function loss1 of the following Equation (1).

loss1=1/NΣ(½ exp(−sigmaᵢ)×|GTᵢ−Predᵢ|)+½Σsigmaᵢ (1)

The loss function loss1 is, for example, a loss function disclosed in “Alex Kendall, Yarin Gal, “What Uncertainties Do We Need in Bayesian Deep Learning for Computer Vision?”, NIPS 2017”. N indicates the number of pixels of the learning image, i indicates an identification number for identifying a pixel of the learning image, Predᵢ indicates a recognition result (an estimation result) of the recognition target in the pixel i by the recognition model, GTᵢ indicates a correct value of the recognition target in the pixel i, and sigmaᵢ indicates reliability of the recognition result Predᵢ of the pixel i.

The recognition model learning unit 366 learns the recognition model so as to minimize a value of the loss function loss1. As a result, a recognition model capable of recognizing a predetermined recognition target and estimating reliability of the recognition result is generated.

Furthermore, for example, in a case where a plurality of vehicles 1-1 to 1-n includes the same vehicle control system 11 and uses the same recognition model, the recognition model learning unit 366 learns the recognition model by using a loss function loss2 of the following Equation (2).

loss2=1/NΣ½|GTᵢ−Predᵢ| (2)

Note that the meaning of each symbol in Equation (2) is similar to that in Equation (1).

The recognition model learning unit 366 learns the recognition model so as to minimize a value of the loss function loss2. As a result, a recognition model capable of recognizing a predetermined recognition target is generated.

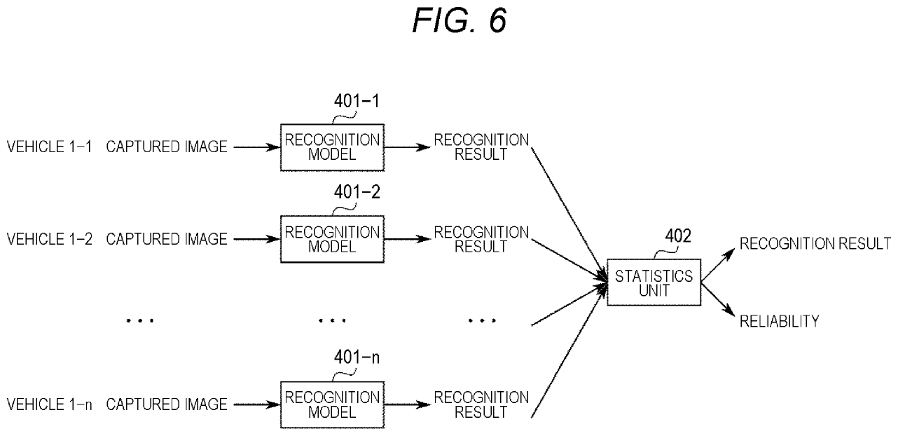

In this case, as illustrated in FIG. 6, the vehicles 1-1 to 1-n perform recognition processing by using recognition models 401-1 to 401-n, respectively, and acquire a recognition result. This recognition result is acquired, for example, as a recognition result image including a recognition value representing a recognition result in each pixel.

A statistics unit 402 calculates a final recognition result and reliability of the recognition result by taking statistics of the recognition results obtained by the recognition models 401-1 to 401-n. The final recognition result is represented by, for example, an image (a recognition result image) including an average value of recognition values for every pixel of the recognition result images obtained by the recognition models 401-1 to 401-n. The reliability is represented by, for example, an image (a reliability image) including a variance of the recognition value for every pixel of the recognition result images obtained by the recognition models 401-1 to 401-n. As a result, the reliability estimation processing can be reduced.

Note that the statistics unit 402 is provided, for example, in the recognition units 331 of the vehicles 1-1 to 1-n.

The recognition model learning unit 366 causes the recognition model storage unit 338 to store the recognition model obtained by learning.

Thereafter, the recognition model learning processing ends.

Note that, for example, in a case where the recognition unit 331 uses a plurality of recognition models having different recognition targets, the recognition model learning processing of FIG. 5 is individually executed for each recognition model.

### First Embodiment of Reliability Threshold Value Setting Processing

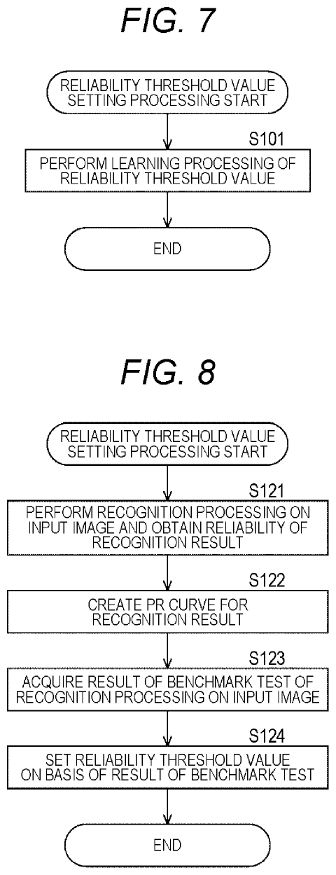

Next, with reference to a flowchart of FIG. 7, a first embodiment of reliability threshold value setting processing executed by the threshold value setting unit 361 will be described.

This processing is executed, for example, before a verification image is collected.

In step S101, the threshold value setting unit 361 performs learning processing of a reliability threshold value. Specifically, the threshold value setting unit 361 learns a reliability threshold value i for reliability of a recognition result of a recognition model, by using a loss function loss3 of the following Equation (3).

loss3=1/NΣ(½ exp(−sigmaᵢ)×GTᵢ−Predᵢ|×Maskᵢ(τ))+1/NΣ(sigmaᵢ×Maskᵢ(τ))−α×log(1−τ) (3)

Maskᵢ (T) is a function having a value of 1 in a case where reliability sigmaᵢ of a recognition result of a pixel i is equal to or larger than the reliability threshold value τ, and having a value of 0 in a case where the reliability sigmaᵢ of the recognition result of the pixel i is smaller than the reliability threshold value τ. The meanings of the other symbols are similar to those of the loss function loss1 of the above Equation (1).

The loss function loss3 is a loss function obtained by adding a loss component of the reliability threshold value τ to the loss function loss1 to be used for learning of a recognition model.

Thereafter, the reliability threshold value setting processing ends.

Note that, for example, in a case where the recognition unit 331 uses a plurality of recognition models having different recognition targets, the reliability threshold value setting processing of FIG. 7 is individually executed for each recognition model. As a result, the reliability threshold value τ can be appropriately set for every recognition model, in accordance with a network structure of each recognition model and a learning image used for each learning model.

Furthermore, by repeatedly executing the reliability threshold value setting processing of FIG. 7 at a predetermined timing, the reliability threshold value can be dynamically updated to an appropriate value.

### Second Embodiment of Reliability Threshold Value Setting Processing

Next, with reference to a flowchart of FIG. 8, a second embodiment of the reliability threshold value setting processing executed by the threshold value setting unit 361 will be described.

This processing is executed, for example, before a verification image is collected.

In step S121, the recognition unit 331 performs recognition processing on an input image and obtains reliability of a recognition result. For example, the recognition unit 331 performs recognition processing on m pieces of input image by using a learned recognition model, and calculates a recognition value representing a recognition result in each pixel of each input image and reliability of the recognition value of each pixel.

In step S122, the threshold value setting unit 361 creates a precision-recall curve (PR curve) for the recognition result.

Specifically, the threshold value setting unit 361 compares a recognition value of each pixel of each input image with a correct value, and determines whether the recognition result of each pixel of each input image is correct or incorrect. For example, the threshold value setting unit 361 determines that the recognition result of the pixel is correct when the recognition value and the correct value match, and determines that the recognition result of the pixel is incorrect when the recognition value and the correct value do not match. Alternatively, for example, the threshold value setting unit 361 determines that the recognition result of the pixel is correct when a difference between the recognition value and the correct value is smaller than a predetermined threshold value, and determines that the recognition result of the pixel is incorrect when a difference between the recognition value and the correct value is equal to or larger than the predetermined threshold value. As a result, the recognition result of each pixel of each input pixel is classified as correct or incorrect.

Next, for example, the threshold value setting unit 361 classifies individual pixels of each input image for every threshold value TH on the basis of correct/incorrect and reliability of the recognition result, while changing a threshold value TH for the reliability of the recognition value from 0 to 1 at a predetermined interval (for example, 0.01).

Specifically, the threshold value setting unit 361 counts a number TP of pixels whose recognition result is correct and a number FP of pixels whose recognition result is incorrect, among pixels whose reliability is equal to or higher than the threshold value TH (the reliability≥the threshold value TH). Furthermore, the threshold value setting unit 361 counts the number of pixels TN whose recognition result is correct and the number of pixels FN whose recognition result is incorrect, among pixels whose reliability is smaller than the threshold value TH (the reliability<the threshold value TH).

Next, for example, the threshold value setting unit 361 calculates Precision (compatibility) and Recall (reproduction ratio) of the recognition model by the following Equations (4) and (5) for every threshold value TH.

Precision=TP/(TP+FP) (4)

Recall=TP/(TP+FN) (5)

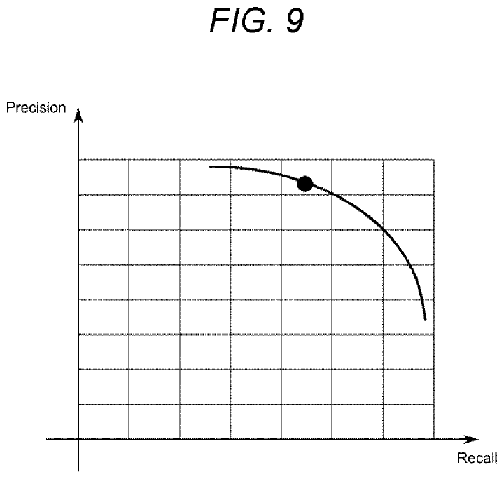

Then, the threshold value setting unit 361 creates the PR curve illustrated in FIG. 9 on the basis of a combination of Precision and Recall at each threshold value TH. Note that a vertical axis of the PR curve in FIG. 9 is Precision, and a horizontal axis is Recall.

In step S123, the threshold value setting unit 361 acquires a result of a benchmark test of recognition processing on the input image. Specifically, the threshold value setting unit 361 uploads an input image group used in the processing of S121, to the server 312 via the communication unit 334 and the network 321.

On the other hand, for example, by using a plurality of pieces of software for a benchmark test for recognizing a recognition target similar to the recognition unit 331 on the input image group, the server 312 performs the benchmark test by a plurality of methods. On the basis of results of the individual benchmark tests, the server 312 obtains a combination of Precision and Recall when Precision is maximum. The server 312 transmits data indicating the obtained combination of Precision and Recall, to the information processing unit 311 via the network 321.

On the other hand, the threshold value setting unit 361 receives data indicating a combination of Precision and Recall via the communication unit 334.

In step S124, the threshold value setting unit 361 sets a reliability threshold value on the basis of the result of the benchmark test. For example, the threshold value setting unit 361 obtains the threshold value TH for Precision acquired from the server 312, in the PR curve created in the processing of step S122. The threshold value setting unit 361 sets the obtained threshold value TH as the reliability threshold value TU.

As a result, the reliability threshold value I can be set such that Precision is as large as possible.

Thereafter, the reliability threshold value setting processing ends.

Note that, for example, in a case where the recognition unit 331 uses a plurality of different recognition models for the recognition target, the reliability threshold value setting processing of FIG. 8 is individually executed for each recognition model. As a result, the reliability threshold value T can be appropriately set for every recognition model.

Furthermore, by repeatedly executing the reliability threshold value setting processing of FIG. 8 at a predetermined timing, the reliability threshold value can be dynamically updated to an appropriate value.

<Verification Image Collection Processing>

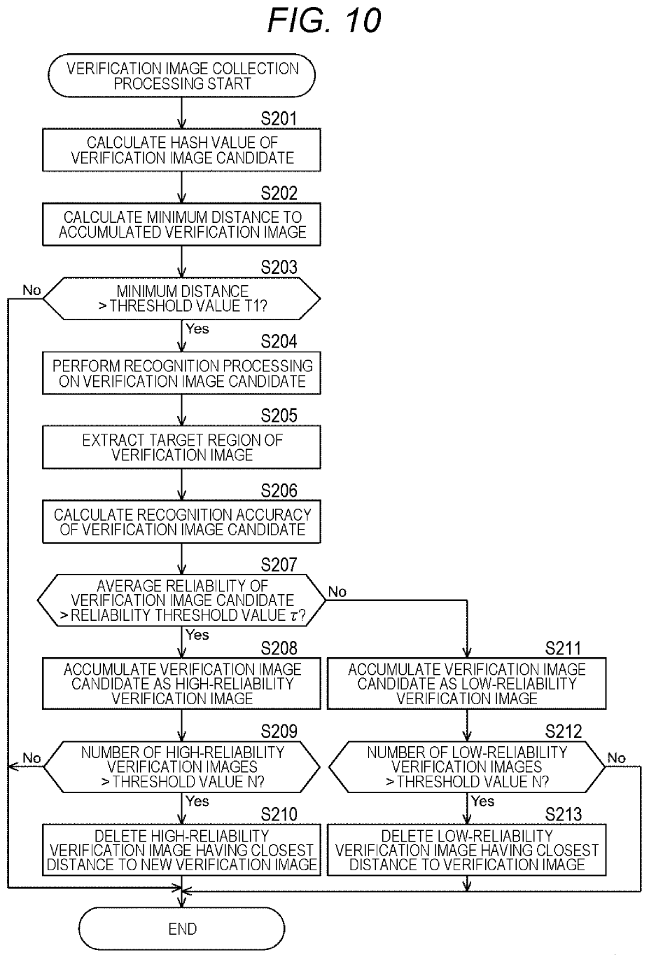

Next, with reference to a flowchart of FIG. 10, verification image collection processing executed by the information processing unit 311 will be described.

This processing is started, for example, when the information processing unit 311 acquires a verification image candidate that is a candidate for the verification image. For example, while the vehicle 1 is traveling, the verification image candidate is captured by the camera 51 and supplied to the information processing unit 311, received from outside via the communication unit 22, or inputted from outside via the HMI 31.

In step S201, the verification image collection unit 362 calculates a hash value of the verification image candidate. For example, the verification image collection unit 362 calculates a 64 bit hash value representing a feature of luminance of the verification image candidate. For this calculation of the hash value, for example, an algorithm called Perceptual Hash disclosed in “C. Zauner, “Implementation and Benchmarking of Perceptual Image Hash Functions,” Upper Austria University of Applied Sciences, Hagenberg Campus, 2010” is used.

In step S202, the verification image collection unit 362 calculates a minimum distance to an accumulated verification image. Specifically, the verification image collection unit 362 calculates a hamming distance between: a hash value of each verification image already accumulated in the high-reliability verification image DB 335 and the low-reliability verification image DB 336; and a hash value of the verification image candidate. Then, the verification image collection unit 362 sets the calculated minimum value of the hamming distance as the minimum distance.

Note that, in a case where no verification image is accumulated in the high-reliability verification image DB 335 and the low-reliability verification image DB 336, the verification image collection unit 362 sets the minimum distance to a fixed value larger than a predetermined threshold value T1.

In step S203, the verification image collection unit 362 determines whether or not the minimum distance>the threshold value T1 is satisfied. When it is determined that the minimum distance>the threshold value T1 is satisfied, that is, in a case where a verification image similar to the verification image candidate has not been accumulated yet, the processing proceeds to step S204.

In step S204, the recognition unit 331 performs recognition processing on the verification image candidate. Specifically, the verification image collection unit 362 supplies the verification image candidate to the recognition unit 331.

The recognition unit 331 performs recognition processing on the verification image candidate by using a current recognition model stored in the recognition model storage unit 338. As a result, the recognition value and the reliability of each pixel of the verification image candidate are calculated, and a recognition result image including the recognition value of each pixel and a reliability image including the reliability of each pixel are generated.

The recognition unit 331 supplies the recognition result image and the reliability image to the verification image collection unit 362.

In step S205, the verification image collection unit 362 extracts a target region of the verification image.

Specifically, the verification image collection unit 362 calculates an average value (hereinafter, referred to as average reliability) of the reliability of each pixel of the reliability image. In a case where the average reliability is equal to or lower than the reliability threshold value i set by the threshold value setting unit 361, that is, in a case where the reliability of the recognition result for the verification image candidate is low as a whole, the verification image collection unit 362 sets the entire verification image candidate as a target of the verification image.

Whereas, in a case where the average reliability exceeds the reliability threshold value τ, the verification image collection unit 362 compares the reliability of each pixel of the reliability image with the reliability threshold value τ. The verification image collection unit 362 classifies individual pixels of the reliability image into a pixel (hereinafter, referred to as a high-reliability pixel) whose reliability is higher than the reliability threshold value τ, and a pixel (hereinafter, referred to as a low reliability pixel) whose reliability is equal to or lower than the reliability threshold value τ. On the basis of a result of classifying each pixel of the reliability image, the verification image collection unit 362 segments the reliability image into a region with high reliability (hereinafter, referred to as a high reliability region) and a region with low reliability (hereinafter, referred to as a low reliability region), by using a predetermined clustering method.

For example, in a case where the largest region among the segmented regions is the high reliability region, the verification image collection unit 362 extracts an image including a rectangular region including the high reliability region from the verification image candidate, to update to the verification image candidate. Whereas, in a case where the largest region among the segmented regions is the low reliability region, the verification image collection unit 362 updates the verification image candidate by extracting an image including a rectangular region including the low reliability region from the verification image candidate.

In step S206, the verification image collection unit 362 calculates recognition accuracy of the verification image candidate. For example, the verification image collection unit 362 calculates Precision for the verification image candidate as the recognition accuracy, by using the reliability threshold value τ by a method similar to the processing in step S121 in FIG. 8 described above.

In step S207, the verification image collection unit 362 determines whether or not the average reliability of the verification image candidates is larger than the reliability threshold value τ (whether or not the average reliability of the verification image candidate>the reliability threshold value τ is satisfied). In a case where it is determined that the average reliability of the verification image candidate is larger than the reliability threshold value τ (the average reliability of the verification image candidate>the reliability threshold value τ is satisfied), the processing proceeds to step S208.

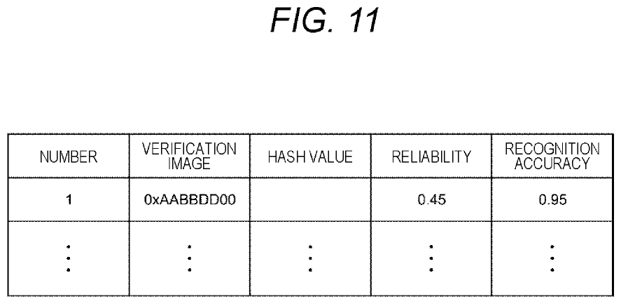

In step S208, the verification image collection unit 362 accumulates the verification image candidate as the high-reliability verification image. For example, the verification image collection unit 362 generates verification image data in a format illustrated in FIG. 11, and accumulates the verification image data in the high-reliability verification image DB 335.

The verification image data includes a number, a verification image, a hash value, reliability, and recognition accuracy.

The number is a number for identifying the verification image.

For the hash value, the hash value calculated in the processing of step S201 is set as the hash value. However, in a case where a part of the verification image candidate is extracted in the processing of step S205, the hash value in the extracted image is calculated and set as the hash value of the verification image data.

As the reliability, the average reliability calculated in the processing of step S205 is set. However, in a case where a part of the verification image candidate is extracted in the processing of step S205, the average reliability in the extracted image is calculated and set as the reliability of the verification image data.

For the recognition accuracy, the recognition accuracy calculated in the processing of step S206 is set.

In step S209, the verification image collection unit 362 determines whether or not the number of high-reliability verification images is larger than a threshold value N (whether or not the number of high-reliability verification images>the threshold value N is satisfied). The verification image collection unit 362 checks the number of high-reliability verification images accumulated in the high-reliability verification image DB 335, and the processing proceeds to step S210 when the verification image collection unit 362 determines that the number of high-reliability verification images is larger than the threshold value N (the number of high-reliability verification images>the threshold value N is satisfied).

In step S210, the verification image collection unit 362 deletes the high-reliability verification image having the closest distance to the new verification image. Specifically, the verification image collection unit 362 individually calculates each hamming distance between: a hash value of a verification image newly accumulated in the high-reliability verification image DB 335; and a hash value of each high-reliability verification image already accumulated in the high-reliability verification image DB 335. Then, the verification image collection unit 362 deletes the high-reliability verification image having the closest hamming distance to the newly accumulated verification image, from the high-reliability verification image DB 335. That is, the high-reliability verification image most similar to the new verification image is deleted.

Thereafter, the verification image collection processing ends.

Whereas, in a case where it is determined in step S209 that the number of high-reliability verification images is equal to or less than the threshold value N (the number of high-reliability verification images≤the threshold value N is satisfied), the processing in step S210 is skipped, and the verification image collection processing ends.

Furthermore, in a case where it is determined in step S207 that the average reliability of the verification image is equal to or lower than the reliability threshold value τ (the average reliability of the verification image≤the reliability threshold value τ is satisfied), the processing proceeds to step S211.

In step S211, the verification image collection unit 362 accumulates the verification image candidate as the low-reliability verification image in the low-reliability verification image DB 336 by processing similar to step S208.

In step S211, the verification image collection unit 362 determines whether or not the number of low-reliability verification images is larger than the threshold value N (whether or not the number of low-reliability verification images>the threshold value N is satisfied). The verification image collection unit 362 checks the number of low-reliability verification images accumulated in the low-reliability verification image DB 336, and the processing proceeds to step S212 when the verification image collection unit 362 determines that the number of low-reliability verification images is larger than the threshold value N (the number of low-reliability verification images>the threshold value N is satisfied).

In step S212, the verification image collection unit 362 deletes the low-reliability verification image having the closest distance to the new verification image. Specifically, the verification image collection unit 362 individually calculates a hamming distance between: a hash value of a verification image newly accumulated in the low-reliability verification image DB 336; and a hash value of each low-reliability verification image already accumulated in the low-reliability verification image DB 336. Then, the verification image collection unit 362 deletes the low-reliability verification image having the closest hamming distance to the newly accumulated verification image, from the low-reliability verification image DB 336. That is, the low-reliability verification image most similar to the new verification image is deleted.

Thereafter, the verification image collection processing ends.

Whereas, in a case where it is determined in step S212 that the number of low-reliability verification images is equal to or less than the threshold value N (the number of low-reliability verification images≤the threshold value N is satisfied), the processing in step S213 is skipped, and the verification image collection processing ends.

Furthermore, when it is determined in step S203 that the minimum distance is equal to or less than the threshold value T1 (the minimum distance≤the threshold value T1 is satisfied), that is, in a case where a verification image similar to the verification image candidate has already been accumulated, the processing of steps S204 to S213 is skipped, and the verification image collection processing ends. In this case, the verification image candidate is not selected as the verification image and is discarded.

For example, this verification image collection processing is repeated, and verification images of an amount necessary for determining whether or not to update the model after relearning of the recognition model are accumulated in the high-reliability verification image DB 335 and the low-reliability verification image DB 336.

As a result, verification images that are not similar to each other can be accumulated, and verification of the recognition model can be efficiently performed.

Note that, for example, in a case where the recognition unit 331 uses a plurality of recognition models having different recognition targets, the verification image collection processing of FIG. 10 may be individually executed for each recognition model, and a different verification image group may be collected for every recognition model.

<Dictionary Data Generation Processing>

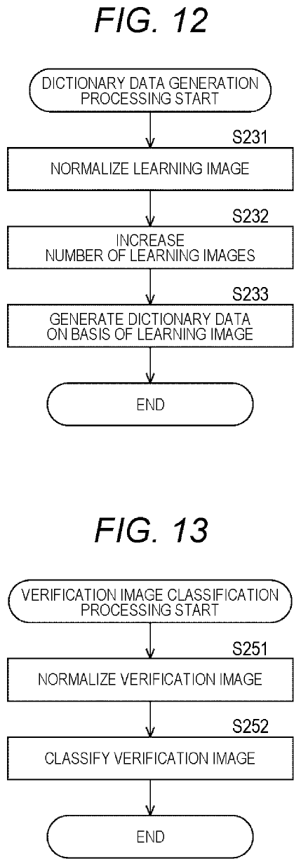

Next, with reference to a flowchart of FIG. 12, dictionary data generation processing executed by the dictionary data generation unit 333 will be described.

This processing is started, for example, when a learning image group including learning images for a plurality of pieces of dictionary data is inputted to the information processing unit 311.

Each learning image included in the learning image group includes a feature that causes decrease in recognition accuracy, and a label indicating the feature is given. Specifically, images including the following features are used.
1. An image with a large backlight region
2. An image with a large shadow region
3. An image having a large region of a reflector such as glass
4. An image having a large region where a similar pattern is repeated
5. An image including a construction site
6. An image including an accident site
7. Other images (images not including the features of 1 to 6)

In step S231, the dictionary data generation unit 333 normalizes a learning image. For example, the dictionary data generation unit 333 normalizes each learning image such that vertical and horizontal resolutions (the number of pixels) have predetermined values.

In step S232, the dictionary data generation unit 333 increases the number of learning images. Specifically, the dictionary data generation unit 333 increases the number of learning images by performing various types of image processing on each normalized learning image. For example, the dictionary data generation unit 333 generates a plurality of learning images from one learning image by individually performing image processing such as addition of Gaussian noise, horizontal inversion, vertical inversion, addition of image blur, and color change, on the learning image. Note that the generated learning image is given with a label same as the original learning image.

In step S233, the dictionary data generation unit 333 generates dictionary data on the basis of the learning image. Specifically, the dictionary data generation unit 333 performs machine learning using each normalized learning image and each learning image generated from each normalized learning image, and generates a classifier that classifies labels of images as the dictionary data. For machine learning, for example, support vector machine (SVMV) is used, and dictionary data (the classifier) is expressed by the following Equation (6).

label=W×X+b (6)

Note that W represents a weight, X represents an input image, b represents a constant, and label represents a predicted value of a label of the input image.

The dictionary data generation unit 333 causes the dictionary data storage unit 339 to store dictionary data and a learning image group used to generate the dictionary data.

Thereafter, the dictionary data generation processing ends.

<Verification Image Classification Processing>

Next, with reference to a flowchart of FIG. 13, verification image classification processing executed by the verification image classification unit 363 will be described.

In step S251, the verification image classification unit 363 normalizes a verification image. For example, the verification image classification unit 363 acquires a verification image having the largest number (most recently accumulated) among unclassified verification images accumulated in the low-reliability verification image DB 336. The verification image classification unit 363 normalizes the acquired verification image by processing similar to step S231 in FIG. 12.

In step S252, the verification image classification unit 363 classifies the verification image on the basis of the dictionary data stored in the dictionary data storage unit 339. That is, the verification image classification unit 363 supplies a label obtained by substituting the verification image into the above-described Equation (6), to the learning image collection unit 365.

Thereafter, the verification image classification processing ends.

This verification image classification processing is executed for all the verification images accumulated in the low-reliability verification image DB 336.

<Learning Image Collection Processing>

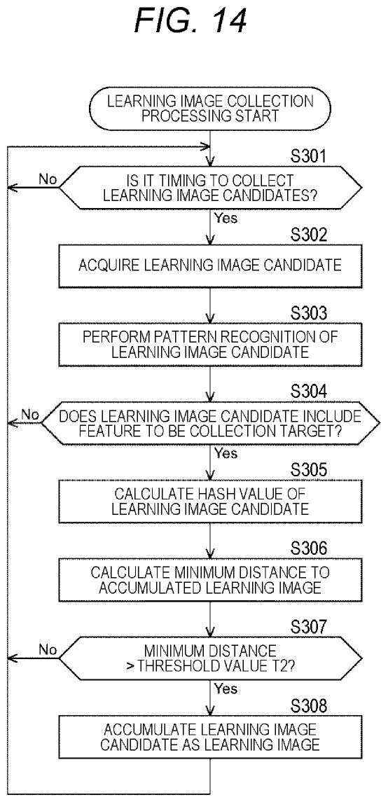

Next, with reference to a flowchart of FIG. 14, learning image collection processing executed by the information processing unit 311 will be described.

This processing is started, for example, when an operation for activating the vehicle 1 and starting driving is performed, for example, when an ignition switch, a power switch, a start switch, or the like of the vehicle 1 is turned ON. Furthermore, this processing ends, for example, when an operation for ending driving of the vehicle 1 is performed, for example, when the ignition switch, the power switch, the start switch, or the like of the vehicle 1 is turned OFF.

In step S301, the collection timing control unit 364 determines whether or not it is a timing to collect the learning image candidates. This determination processing is repeatedly executed until it is determined that it is the timing to collect the learning image candidates. Then, in a case where a predetermined condition is satisfied, the learning image collection unit 365 determines that it is the timing to collect the learning image candidates, and the processing proceeds to step S302.

Hereinafter, an example of the timing to collect the learning image candidates will be described.

For example, a timing is assumed at which an image having a feature different from that of a learning image used for learning of a recognition model in the past can be collected.

Specifically, for example, the following cases are assumed.
(1) A case where the vehicle 1 is traveling in a place where no learning image candidate has been collected (for example, a place where the vehicle has never traveled before).
(2) A case where an image is received from outside (for example, other vehicles, service centers, and the like).

For example, a timing is assumed at which it is possible to collect an image obtained by capturing a place where high recognition accuracy is required or a place where the recognition accuracy is likely to decrease. As the place where high recognition accuracy is required, for example, a place where an accident is likely to occur, a place with a large traffic volume, or the like is assumed. Specifically, for example, the following cases are assumed.
(3) A case where the vehicle 1 is traveling near a place where an accident of a vehicle including the same vehicle control system 11 as that of the vehicle 1 has occurred in the past.
(4) A case where the vehicle 1 is traveling near a newly installed construction site.

For example, a timing is assumed at which a factor that causes decrease in recognition accuracy of the recognition model has occurred. Specifically, for example, the following cases are assumed.
(5) A case where at least one of a change of the camera 51 (the image sensor) installed in the vehicle 1 or a change of an installation position of the camera 51 (the image sensor) has occurred. The change of the camera 51 includes, for example, replacement of the camera 51 and new installation of the camera 51. The change of the installation position of the camera 51 includes, for example, a movement of an installation position of the camera 51 and a change of an image-capturing direction of the camera 51.
(6) A case where an average value of reliability of a recognition result (the above-described average reliability) by the recognition unit 331 has decreased. That is, a case where the reliability of the recognition result of the current recognition model has decreased.

In step S302, the learning image collection unit 365 acquires a learning image candidate. For example, the learning image collection unit 365 acquires a captured image captured by the camera 51 as the learning image candidate. For example, the learning image collection unit 365 acquires an image received from outside via the communication unit 334, as the learning image candidate.

In step S303, the learning image collection unit 365 performs pattern recognition of the learning image candidate. For example, the learning image collection unit 365 performs product-sum operation of the above-described Equation (6) on an image in each target region by using the dictionary data stored in the dictionary data storage unit 339, while scanning a target region to be subjected to pattern recognition in a learning image candidate in a predetermined direction. As a result, a label indicating a feature of each region of the learning image candidate is obtained.

In step S304, the learning image collection unit 365 determines whether or not the learning image candidate includes a feature to be a collection target. In a case where there is no label matching the label representing the recognition result of the low-reliability verification image described above among the labels given to the individual regions of the learning image candidates, the learning image collection unit 365 determines that the learning image candidate does not include a feature to be the collection target, and the processing returns to step S301. In this case, the learning image candidate is not selected as the learning image and is discarded.

Thereafter, the processing of steps S301 to S304 is repeatedly executed until it is determined in step S304 that the learning image candidate includes a feature to be a collection target.

Whereas, in step S304, in a case where there is a label matching the label representing the recognition result of the low-reliability verification image described above among the labels given to the individual regions of the learning image candidates, the learning image collection unit 365 determines that the learning image candidate includes a feature to be the collection target, and the processing proceeds to step S305.

In step S305, the learning image collection unit 365 calculates a hash value of the learning image candidate by processing similar to that in step S201 in FIG. 10 described above.

In step S306, the learning image collection unit 365 calculates a minimum distance to an accumulated learning image. Specifically, the learning image collection unit 365 calculates a hamming distance between: a hash value of each learning image already accumulated in the learning image DB 337; and a hash value of the learning image candidate. Then, the learning image collection unit 365 sets the calculated minimum value of the hamming distance as the minimum distance.

In step S307, the learning image collection unit 365 determines whether or not the minimum distance>a threshold value T2 is satisfied. In a case where that the minimum distance>the threshold value T2 is satisfied, that is, in a case where a learning image similar to the learning image candidate has not been accumulated yet, the processing proceeds to step S308.

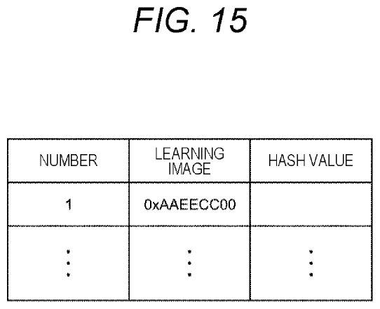

In step S308, the learning image collection unit 365 accumulates the learning image candidate as the learning image. For example, the learning image collection unit 365 generates learning image data in a format illustrated in FIG. 15, and accumulates the learning image data in the learning image DB 337.

The learning image data includes a number, a learning image, and a hash value.

The number is a number for identifying the learning image.

For the hash value, the hash value calculated in the processing of step S305 is set as the hash value.

Thereafter, the processing returns to step S301, and the processing in and after step S301 is executed.

Whereas, when it is determined in step S307 that the minimum distance≤the threshold value T2 is satisfied, that is, in a case where a learning image similar to the learning image candidate has already been accumulated, the processing returns to step S301. That is, in this case, the learning image candidate is not selected as the learning image and is discarded.

Thereafter, the processing in and after step S301 is executed.

Note that, for example, in a case where the recognition unit 331 uses a plurality of recognition models having different recognition targets, the learning image collection processing of FIG. 14 may be executed individually for each recognition model, and the learning image may be collected for every recognition model.

<Recognition Model Update Processing>

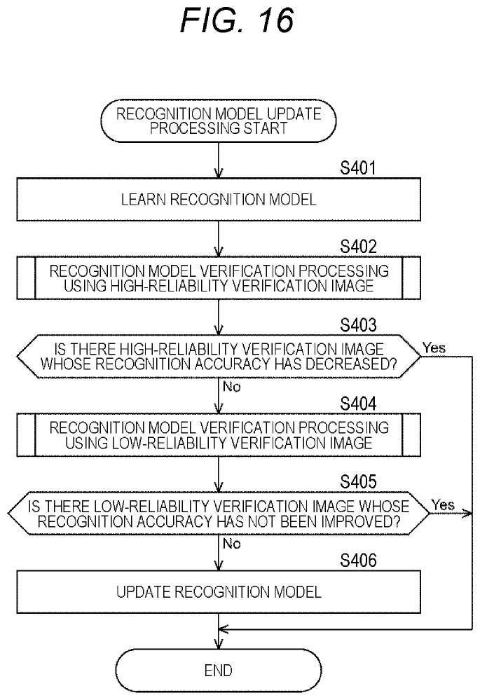

Next, with reference to a flowchart of FIG. 16, recognition model update processing executed by the information processing unit 311 will be described.

This processing is executed, for example, at a predetermined timing. For example, a case is assumed in which an accumulation amount of learning images in the learning image DB 337 exceeds a predetermined threshold value, or the like.

In step S401, the recognition model learning unit 366 learns a recognition model by using learning images accumulated in the learning image DB 337, similarly to the processing in step S101 in FIG. 5. The recognition model learning unit 366 supplies the generated recognition model to the recognition model update control unit 367.

In step S402, the recognition model update control unit 367 executes recognition model verification processing using a high-reliability verification image.

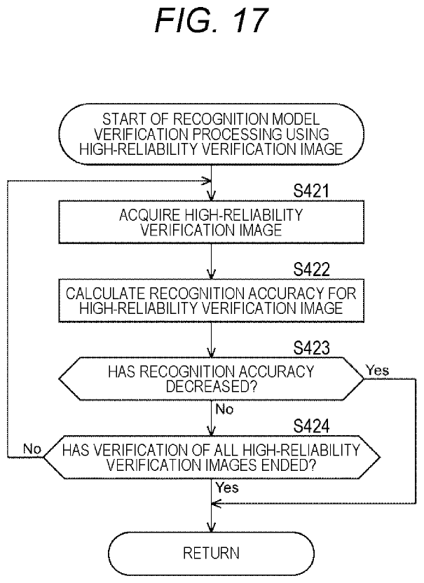

Here, with reference to the flowchart of FIG. 17, details of the recognition model verification processing using a high-reliability verification image will be described.

In step S421, the recognition model update control unit 367 acquires a high-reliability verification image. Specifically, among the high-reliability verification images accumulated in the high-reliability verification image DB 335, the recognition model update control unit 367 acquires one high-reliability verification image that is not yet used for verification of a recognition model, from the high-reliability verification image DB 335.

In step S422, the recognition model update control unit 367 calculates recognition accuracy for the verification image. Specifically, the recognition model update control unit 367 performs recognition processing on the acquired high-reliability verification image by using the recognition model (a new recognition model) obtained in the processing of step S401. Furthermore, the recognition model update control unit 367 calculates the recognition accuracy of the high-reliability verification image by processing similar to step S206 in FIG. 10 described above.

In step S423, the recognition model update control unit 367 determines whether or not the recognition accuracy has decreased. The recognition model update control unit 367 compares the recognition accuracy calculated in the processing of step S422 with the recognition accuracy included in the verification image data including the target high-reliability verification image. That is, the recognition model update control unit 367 compares the recognition accuracy of the new recognition model for the high-reliability verification image with the recognition accuracy of the current recognition model for the high-reliability verification image. In a case where the recognition accuracy of the new recognition model is equal to or higher than the recognition accuracy of the current recognition model, the recognition model update control unit 367 determines that the recognition accuracy has not decreased, and the processing proceeds to step S424.

In step S424, the recognition model update control unit 367 determines whether or not verification of all the high-reliability verification images has ended. In a case where a high-reliability verification image that has not been verified yet remains in the high-reliability verification image DB 335, the recognition model update control unit 367 determines that the verification of all the high-reliability verification images has not ended yet, and the processing returns to step S421.

Thereafter, the processing of steps S421 to S424 is repeatedly executed until it is determined in step S423 that the recognition accuracy has decreased or it is determined in step S424 that the verification of all the high-reliability verification images has ended.

Whereas, when it is determined in step S424 that the verification of all the high-reliability verification images has ended, the recognition model verification processing ends. This is a case where the recognition accuracy of the new recognition model is equal to or higher than the recognition accuracy of the current recognition model for all the high-reliability verification images.

Furthermore, in step S423, in a case where the recognition accuracy of the new recognition model is lower than the recognition accuracy of the current recognition model, the recognition model update control unit 367 determines that the recognition accuracy has decreased, and the recognition model verification processing ends. This is a case where there is a high-reliability verification image in which the recognition accuracy of the new recognition model is lower than the recognition accuracy of the current recognition model.

Returning to FIG. 16, in step S403, the recognition model update control unit 367 determines whether or not there is a high-reliability verification image whose recognition accuracy has decreased. In a case where the recognition model update control unit 367 determines that there is no high-reliability verification image in which the recognition accuracy of the new recognition model has decreased as compared with that of the current recognition model on the basis of the result of the processing in step S402, the processing proceeds to step S404.

In step S404, the recognition model update control unit 367 executes recognition model verification processing using a low-reliability verification image.

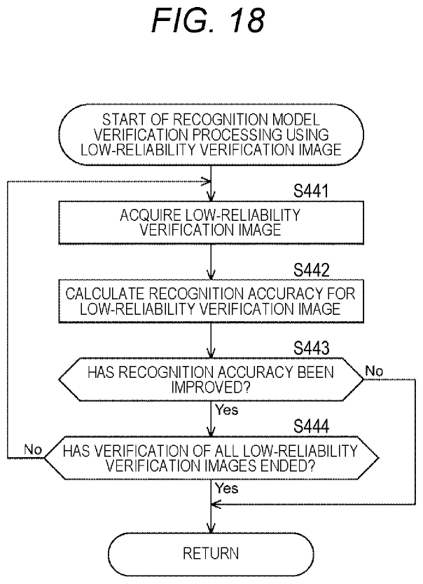

Here, with reference to the flowchart of FIG. 18, details of the recognition model verification processing using a low-reliability verification image will be described.

In step S441, the recognition model update control unit 367 acquires a low-reliability verification image. Specifically, among the low-reliability verification images accumulated in the low-reliability verification image DB 336, the recognition model update control unit 367 acquires one low-reliability verification image that has not yet been used for verification of a recognition model, from the low-reliability verification image DB 336.

In step S442, the recognition model update control unit 367 calculates recognition accuracy for the verification image. Specifically, the recognition model update control unit 367 performs recognition processing on the acquired low-reliability verification image by using the recognition model (a new recognition model) obtained in the processing of step S401. Furthermore, the recognition model update control unit 367 calculates the recognition accuracy of the low-reliability verification image by processing similar to step S206 in FIG. 10 described above.

In step S443, the recognition model update control unit 367 determines whether or not the recognition accuracy has been improved. The recognition model update control unit 367 compares the recognition accuracy calculated in the processing of step S442 with the recognition accuracy included in the verification image data including the target low-reliability verification image. That is, the recognition model update control unit 367 compares the recognition accuracy of the new recognition model for the low-reliability verification image with the recognition accuracy of the current recognition model for the low-reliability verification image. In a case where the recognition accuracy of the new recognition model exceeds the recognition accuracy of the current recognition model, the recognition model update control unit 367 determines that the recognition accuracy has been improved, and the processing proceeds to step S444.

In step S444, the recognition model update control unit 367 determines whether or not verification of all the low-reliability verification images has ended. In a case where a low-reliability verification image that has not been verified yet remains in the low-reliability verification image DB 336, the recognition model update control unit 367 determines that the verification of all the low-reliability verification images has not ended yet, and the processing returns to step S441.

Thereafter, the processing of steps S441 to S444 is repeatedly executed until it is determined in step S443 that the recognition accuracy is not improved or it is determined in step S444 that the verification of all the low-reliability verification images has ended.

Whereas, when it is determined in step S444 that the verification of all the low-reliability verification images has ended, the recognition model verification processing ends. This is a case where the recognition accuracy of the new recognition model exceeds the recognition accuracy of the current recognition model for all the low-reliability verification images.

Furthermore, in step S423, in a case where the recognition accuracy of the new recognition model is equal to or lower than the recognition accuracy of the current recognition model, the recognition model update control unit 367 determines that the recognition accuracy is not improved, and the recognition model verification processing ends. This is a case where there is a low-reliability verification image in which the recognition accuracy of the new recognition model is equal to or lower than the recognition accuracy of the current recognition model.

Returning to FIG. 16, in step S405, the recognition model update control unit 367 determines whether or not there is a low-reliability verification image whose recognition accuracy has not been improved. In a case where the recognition model update control unit 367 determines that there is no high-reliability verification image in which the recognition accuracy of the new recognition model is not improved as compared with the current recognition model on the basis of the result of the processing in step S404, the processing proceeds to step S406.

In step S406, the recognition model update control unit 367 updates the recognition model. Specifically, the recognition model update control unit 367 updates the current recognition model stored in the recognition model storage unit 338 to the new recognition model.

Thereafter, the recognition model update processing ends.

Whereas, in step S405, when the recognition model update control unit 367 determines that there is a high-reliability verification image in which the recognition accuracy of the new recognition model is not improved as compared with the current recognition model on the basis of the result of the processing in step S404, the processing in step S406 is skipped, and the recognition model update processing ends. In this case, the recognition model is not updated.

Furthermore, in step S403, in a case where the recognition model update control unit 367 determines that there is a high-reliability verification image in which the recognition accuracy of the new recognition model has decreased as compared with that of the current recognition model on the basis of the result of the processing in step S402, the processing in steps S403 to S406 is skipped, and the recognition model update processing ends. In this case, the recognition model is not updated.

Note that the order of the processing in steps S402 and S403 and the processing in steps S404 and S405 can be changed, or both can be executed in parallel.

Furthermore, for example, in a case where the recognition unit 331 uses a plurality of recognition models having different recognition targets, the recognition model update processing of FIG. 16 is individually executed for each recognition model, and the recognition models are individually updated.

As described above, it is possible to efficiently collect various learning images and verification images without bias. Therefore, the recognition model can be efficiently relearned, and the recognition accuracy of the recognition model can be improved. Furthermore, by dynamically setting the reliability threshold value τ for every recognition model, the verification accuracy of each recognition model is improved, and as a result, the recognition accuracy of each recognition model is improved.

### 3. Modified Example

Hereinafter, a modified example of the above-described embodiment of the present technology will be described.

For example, the collection timing control unit 364 may control a timing to collect the learning image candidates on the basis of an environment in which the vehicle 1 is traveling. For example, the collection timing control unit 364 may control to collect the learning image candidates in a case where the vehicle 1 is traveling in rain, snow, smog, or haze, which causes decrease in recognition accuracy of the recognition model.

A machine learning method to which the present technology is applied is not particularly limited. For example, the present technology is applicable to both supervised learning and unsupervised learning. Furthermore, in a case where the present technology is applied to supervised learning, a way of giving correct data is not particularly limited. For example, in a case where the recognition unit 331 performs depth recognition of a captured image captured by the camera 51, correct data is generated on the basis of data acquired by the LiDAR 53.

The present technology can also be applied to a case of learning a recognition model for recognizing a predetermined recognition target using sensing data (for example, the radar 52, the LiDAR 53, the ultrasonic sensor 54, and the like) other than an image. In this case, learning data and verification data (for example, point cloud, millimeter wave data, and the like) acquired by each sensor different from the learning image and the verification image described above are used for learning. Furthermore, the present technology can also be applied to a case of learning a recognition model for recognizing a predetermined recognition target by using two or more types of sensing data including an image.

The present technology can also be applied to, for example, a case of learning a recognition model for recognizing a recognition target in the vehicle 1.

The present technology can also be applied to, for example, a case of learning a recognition model for recognizing a recognition target around or inside a mobile object other than a vehicle. For example, a mobile object such as a motorcycle, a bicycle, a personal mobility, an airplane, a ship, a construction machine, an agricultural machine (tractor) and the like are assumed. Furthermore, the mobile object to which the present technology can be applied also includes, for example, a mobile object that is remotely driven (operated) without being boarded by a user, such as a drone or a robot.

The present technology can also be applied to, for example, a case of learning a recognition model for recognizing a recognition target in a place other than a mobile object.

### 4. Other

<Computer Configuration Example>

The series of processes described above can be executed by hardware or also executed by software. In a case where the series of processes are performed by software, a program that configures the software is installed in a computer. Here, examples of the computer include, for example, a computer that is built in dedicated hardware, a general-purpose personal computer that can perform various functions by being installed with various programs, and the like.

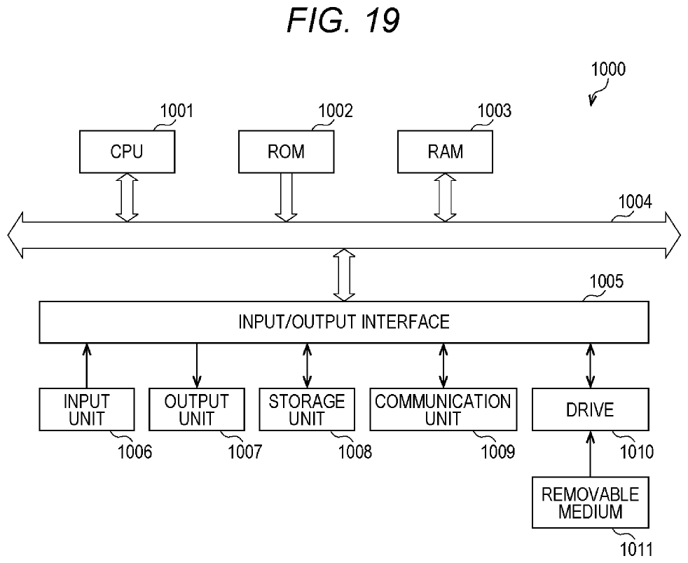

FIG. 19 is a block diagram illustrating a configuration example of hardware of a computer that executes the series of processes described above in accordance with a program.

In a computer 1000, a central processing unit (CPU) 1001, a read only memory (ROM) 1002, and a random access memory (RAN) 1003 are mutually connected by a bus 1004.

The bus 1004 is further connected with an input/output interface 1005. To the input/output interface 1005, an input unit 1006, an output unit 1007, a recording unit 1008, a communication unit 1009, and a drive 1010 are connected.

The input unit 1006 includes an input switch, a button, a microphone, an image sensor, and the like. The output unit 1007 includes a display, a speaker, and the like. The recording unit 1008 includes a hard disk, a non-volatile memory, and the like. The communication unit 1009 includes a network interface or the like. The drive 1010 drives a removable medium 1011 such as a magnetic disk, an optical disk, a magneto-optical disk, or a semiconductor memory.

In the computer 1000 configured as described above, the series of processes described above are performed, for example, by the CPU 1001 loading a program recorded in the recording unit 1008 into the RAM 1003 via the input/output interface 1005 and the bus 1004, and executing.

The program executed by the computer 1000 (the CPU 1001) can be provided by being recorded on, for example, the removable medium 1011 as a package medium or the like. Furthermore, the program can be provided via a wired or wireless transmission medium such as a local area network, the Internet, or digital satellite broadcasting.

In the computer 1000, by attaching the removable medium 1011 to the drive 1010, the program can be installed in the recording unit 1008 via the input/output interface 1005. Furthermore, the program can be received by the communication unit 1009 via a wired or wireless transmission medium, and installed in the recording unit 1008. Besides, the program can be installed in advance in the ROM 1002 and the recording unit 1008.

Note that the program executed by the computer may be a program that performs processing in time series according to an order described in this specification, or may be a program that performs processing in parallel or at necessary timing such as when a call is made.

Furthermore, in this specification, the system means a set of a plurality of components (a device, a module (a part), and the like), and it does not matter whether or not all the components are in the same housing. Therefore, a plurality of devices housed in separate housings and connected via a network, and a single device with a plurality of modules housed in one housing are both systems.

Moreover, the embodiment of the present technology is not limited to the above-described embodiment, and various modifications can be made without departing from the scope of the present technology.

For example, the present technology can have a cloud computing configuration in which one function is shared and processed in cooperation by a plurality of devices via a network.

Furthermore, each step described in the above-described flowchart can be executed by one device, and also shared and executed by a plurality of devices.

Moreover, in a case where one step includes a plurality of processes, the plurality of processes included in the one step can be executed by one device, and also shared and executed by a plurality of devices.

<Combination Example of Configuration>

The present technology can also have the following configurations.

(1)

An information processing apparatus including:

a collection timing control unit configured to control a timing to collect a learning image candidate that is an image to be a candidate for a learning image to be used in relearning of a recognition model; and

a learning image collection unit configured to select the learning image from among the learning image candidates that have been collected, on the basis of at least one of a feature of the learning image candidate or a similarity to the learning image that has been accumulated.

(2)

The information processing apparatus according to (1) above, in which

the recognition model is used to recognize a predetermined recognition target around a vehicle, and

the learning image collection unit selects the learning image from among the learning image candidates including an image obtained by capturing an image of surroundings of the vehicle by an image sensor installed in the vehicle.

(3)

The information processing apparatus according to (2) above, in which

the collection timing control unit controls a timing to collect the learning image candidate on the basis of at least one of a place or an environment in which the vehicle is traveling.

(4)

The information processing apparatus according to (3) above, in which

the collection timing control unit performs control to collect the learning image candidate in at least one of a place where the learning image candidate has not been collected, a vicinity of a newly installed construction site, or a vicinity of a place where an accident of a vehicle including a system similar to a vehicle control system provided in the vehicle has occurred.

(5)

The information processing apparatus according to any one of (2) to (4) above, in which

the collection timing control unit performs control to collect the learning image candidate when reliability of a recognition result by the recognition model has decreased while the vehicle is traveling.

(6)

The information processing apparatus according to any one of (2) to (5) above, in which

the collection timing control unit performs control to collect the learning image candidate when at least one of a change of the image sensor installed in the vehicle or a change of an installation position of the image sensor occurs.

(7)

The information processing apparatus according to any one of (2) to (6) above, in which

when the vehicle receives an image from outside, the collection timing control unit performs control to collect the received image as the learning image candidate.

(8)

The information processing apparatus according to any one of (1) to (7) above, in which

the learning image collection unit selects the learning image from among the learning image candidates including at least one of a backlight region, a shadow, a reflector, a region in which a similar pattern is repeated, a construction site, an accident site, rain, snow, smog, or haze.

(9)

The information processing apparatus according to any one of (1) to (8) above, further including:

a verification image collection unit configured to select the verification image from among verification image candidates that are images to be a candidate for the verification image to be used for verification of the recognition model, on the basis of similarity to the verification image that has been accumulated.

(10)

The information processing apparatus according to (9) above, further including:

a learning unit configured to relearn the recognition model by using the learning image that has been collected; and

a recognition model update control unit configured to control update of the recognition model on the basis of a result of comparison between: recognition accuracy of a first recognition for the verification image, the first recognition model being the recognition model before relearning; and recognition accuracy of a second recognition model for the verification image, the second recognition model being the recognition model obtained by relearning.

(11)

The information processing apparatus according to (10) above, in which

on the basis of reliability of a recognition result of the first recognition model for the verification image, the verification image collection unit classifies the verification image into a high-reliability verification image having high reliability or a low-reliability verification image having low reliability, and

the recognition model update control unit updates the first recognition model to the second recognition model in a case where recognition accuracy of the second recognition model for the high-reliability verification image has not decreased as compared with recognition accuracy of the first recognition model for the high-reliability verification image, and recognition accuracy of the second recognition model for the low-reliability verification image has been improved as compared with recognition accuracy of the first recognition model for the low-reliability verification image.

(12)

The information processing apparatus according to (9) above, in which

the recognition model recognizes a predetermined recognition target for every pixel of an input image and estimates reliability of a recognition result, and

the verification image collection unit extracts a region to be used for the verification image in the verification image candidate, on the basis of a result of comparison between: reliability of a recognition result for every pixel of the verification image candidate by the recognition model; and a threshold value that is dynamically set.

(13)

The information processing apparatus according to (12) above, further including:

a threshold value setting unit configured to learn the threshold value by using a loss function obtained by adding a loss component of the threshold value to a loss function to be used for learning the recognition model.

(14)

The information processing apparatus according to (12) above, further including:

a threshold value setting unit configured to set the threshold value, on the basis of a recognition result for an input image by the recognition model and a recognition result for the input image by software for a benchmark test for recognizing a recognition target same as a recognition target of the recognition model.

(15)

The information processing apparatus according to any one of (12) to (14), further including:

a recognition model learning unit configured to relearn the recognition model by using a loss function including the reliability.

(16)

The information processing apparatus according to any one of (1) to (15), further including:

a recognition unit configured to recognize a predetermined recognition target by using the recognition model and estimate reliability of a recognition result.

(17)

The information processing apparatus according to (16) above, in which

the recognition unit estimates the reliability by taking statistics with a recognition result by another recognition model.

(18)

The information processing apparatus according to (1) above, further including:

a learning unit configured to relearn the recognition model by using the learning image that has been collected.

(19)

An information processing method including,

by an information processing apparatus:

controlling a timing to collect a learning image candidate that is an image to be a candidate for a learning image to be used in relearning of a recognition model; and

selecting the learning image from among the learning image candidates that have been collected, on the basis of at least one of a feature of the learning image candidate or a similarity to the learning image that has been accumulated.

(20)

A program for causing a computer to execute processing including:

controlling a timing to collect a learning image candidate that is an image to be a candidate for a learning image to be used in relearning of a recognition model; and

selecting the learning image from among the learning image candidates that have been collected, on the basis of at least one of a feature of the learning image candidate or a similarity to the learning image that has been accumulated.

Note that the effects described in this specification are merely examples and are not limited, and other effects may be present.

### REFERENCE SIGNS LIST

1 Vehicle
11 Vehicle control system
51 Camera
73 Recognition unit
301 Information processing system
311 Information processing unit
312 Server
331 Recognition unit
332 Learning unit
333 Dictionary data generation unit
361 Threshold value setting unit
362 Verification image collection unit
363 Verification image classification unit
364 Collection timing control unit
365 Learning image collection unit
366 Recognition model learning unit
367 Recognition model update control unit

1. An information processing apparatus comprising:
a collection timing control unit configured to control a timing to collect a learning image candidate that is an image to be a candidate for a learning image to be used in relearning of a recognition model; and
a learning image collection unit configured to select the learning image from among the learning image candidates that have been collected, on a basis of at least one of a feature of the learning image candidate or a similarity to the learning image that has been accumulated.

2. The information processing apparatus according to claim 1, wherein
the recognition model is used to recognize a predetermined recognition target around a vehicle, and
the learning image collection unit selects the learning image from among the learning image candidates including an image obtained by capturing an image of surroundings of the vehicle by an image sensor installed in the vehicle.

3. The information processing apparatus according to claim 2, wherein
the collection timing control unit controls a timing to collect the learning image candidate on a basis of at least one of a place or an environment in which the vehicle is traveling.

4. The information processing apparatus according to claim 3, wherein
the collection timing control unit performs control to collect the learning image candidate in at least one of a place where the learning image candidate has not been collected, a vicinity of a newly installed construction site, or a vicinity of a place where an accident of a vehicle including a system similar to a vehicle control system provided in the vehicle has occurred.

5. The information processing apparatus according to claim 2, wherein
the collection timing control unit performs control to collect the learning image candidate when reliability of a recognition result by the recognition model has decreased while the vehicle is traveling.

6. The information processing apparatus according to claim 2, wherein
the collection timing control unit performs control to collect the learning image candidate when at least one of a change of the image sensor installed in the vehicle or a change of an installation position of the image sensor occurs.

7. The information processing apparatus according to claim 2, wherein
when the vehicle receives an image from outside, the collection timing control unit performs control to collect the received image as the learning image candidate.

8. The information processing apparatus according to claim 1, wherein
the learning image collection unit selects the learning image from among the learning image candidates including at least one of a backlight region, a shadow, a reflector, a region in which a similar pattern is repeated, a construction site, an accident site, rain, snow, smog, or haze.

9. The information processing apparatus according to claim 1, further comprising:
a verification image collection unit configured to select the verification image from among verification image candidates that are images to be a candidate for the verification image to be used for verification of the recognition model, on a basis of similarity to the verification image that has been accumulated.

10. The information processing apparatus according to claim 9, further comprising:
a learning unit configured to relearn the recognition model by using the learning image that has been collected; and
a recognition model update control unit configured to control update of the recognition model on a basis of a result of comparison between: recognition accuracy of a first recognition for the verification image, the first recognition model being the recognition model before relearning; and recognition accuracy of a second recognition model for the verification image, the second recognition model being the recognition model obtained by relearning.

11. The information processing apparatus according to claim 10, wherein
on a basis of reliability of a recognition result of the first recognition model for the verification image, the verification image collection unit classifies the verification image into a high-reliability verification image having high reliability or a low-reliability verification image having low reliability, and
the recognition model update control unit updates the first recognition model to the second recognition model in a case where recognition accuracy of the second recognition model for the high-reliability verification image has not decreased as compared with recognition accuracy of the first recognition model for the high-reliability verification image, and recognition accuracy of the second recognition model for the low-reliability verification image has been improved as compared with recognition accuracy of the first recognition model for the low-reliability verification image.

12. The information processing apparatus according to claim 9, wherein
the recognition model recognizes a predetermined recognition target for every pixel of an input image and estimates reliability of a recognition result, and
the verification image collection unit extracts a region to be used for the verification image in the verification image candidate, on a basis of a result of comparison between: reliability of a recognition result for every pixel of the verification image candidate by the recognition model; and a threshold value that is dynamically set.

13. The information processing apparatus according to claim 12, further comprising:
a threshold value setting unit configured to learn the threshold value by using a loss function obtained by adding a loss component of the threshold value to a loss function to be used for learning the recognition model.

14. The information processing apparatus according to claim 12, further comprising:
a threshold value setting unit configured to set the threshold value, on a basis of a recognition result for an input image by the recognition model and a recognition result for the input image by software for a benchmark test for recognizing a recognition target same as a recognition target of the recognition model.

15. The information processing apparatus according to claim 12, further comprising:
a recognition model learning unit configured to relearn the recognition model by using a loss function including the reliability.

16. The information processing apparatus according to claim 1, further comprising:
a recognition unit configured to recognize a predetermined recognition target by using the recognition model and estimate reliability of a recognition result.

17. The information processing apparatus according to claim 16, wherein
the recognition unit estimates the reliability by taking statistics with a recognition result by another recognition model.

18. The information processing apparatus according to claim 1, further comprising:
a learning unit configured to relearn the recognition model by using the learning image that has been collected.

19. An information processing method comprising,
by an information processing apparatus:
controlling a timing to collect a learning image candidate that is an image to be a candidate for a learning image to be used in relearning of a recognition model; and
selecting the learning image from among the learning image candidates that have been collected, on a basis of at least one of a feature of the learning image candidate or a similarity to the learning image that has been accumulated.

20. A program for causing a computer to execute processing comprising:
controlling a timing to collect a learning image candidate that is an image to be a candidate for a learning image to be used in relearning of a recognition model; and
selecting the learning image from among the learning image candidates that have been collected, on a basis of at least one of a feature of the learning image candidate or a similarity to the learning image that has been accumulated.
